(19) United States
(12) Patent Application Publication
(10) Pub. No.: US 2023/0407423 A1
(43) Pub. Date: Dec. 21, 2023

(54) BIOMASS DIRECT REDUCED IRON

(71) Applicant: Technological Resources Pty. Limited, Melbourne (AU)

(72) Inventor: Michael Buckley, Perth, Western Australia (AU)

(21) Appl. No.: 18/038,139

(22) PCT Filed: Nov. 24, 2021
(86) PCT No.: PCT/AU2021/051400

§ 371 Date: May 22, 2023

(30) Foreign Application Priority Data
Nov. 24, 2020 (AU) 2020904337

(51) Int. Cl. C21B 13/00; C21B 13/10; C21B 13/14; C21B 13/12; F27D 17/00; F27B 9/12; F27D 11/12; F27B 9/30

(52) U.S. Cl. CPC C21B 13/004; C21B 13/10; C21B 13/146; C21B 13/0046; C21B 13/12; C21B 13/008; F27D 17/004; F27B 9/12; F27D 11/12; F27B 9/3005; C21B 2100/60; F27B 2009/122; F27D 2099/0028

(57) ABSTRACT

A method and an apparatus for “recycling” a significant amount of heat within a linear hearth furnace by means of an endless conveyor that transports briquettes through the furnace from an inlet (briquette feed) end to an outlet (DRI discharge) end and then returns to the inlet end and transfers a significant amount of heat from the outlet end to the inlet end of the furnace.

### TECHNICAL FIELD

The present invention relates to a method and an apparatus for producing direct reduced iron (DRI) from iron ore and biomass.

The present invention relates particularly, although by no means exclusively, to a method and an apparatus for producing DRI continuously using a furnace having interlinked furnace zones with biomass as a reductant and heat source and electromagnetic energy as a supplemental energy source to facilitate further heating and reduction.

Such DRI, for example while hot, may be subsequently melted in a furnace to create hot metal, then cast as pig iron or refined further to steel in a metallurgical furnace. Alternatively, the hot DRI may be compressed between a pair of rollers with aligning pockets to form a hot briquetted iron (HBI), which can subsequently be supplied to a furnace as a cold charge.

The term “direct reduced iron” is understood herein to mean iron produced from the direct reduction of iron ore to iron by a reducing agent at temperatures below the bulk melting temperature of the solids. For the purposes of the discussion herein “direct reduced iron” (DRI) is understood to have at least 85% metallisation.

The term “metallisation” is understood herein to mean the extent of conversion of iron oxide into metallic iron during reduction of the iron oxide, as a percentage of the mass of metallic iron divided by the mass of total iron.

### BACKGROUND

Iron and steel making are historically carbon intensive processes in which the majority of the carbon used is eventually oxidised to CO₂ and discharged to the atmosphere. With the world seeking to reduce overall atmospheric CO₂ there is pressure on iron and steel makers to find means to make iron and steel without causing net emissions of greenhouse gases. In particular there is pressure to not use coal and natural gas, which are considered non-renewable.

The majority of iron in the world is produced by the blast furnace route, which is a technology that has existed since prior to the industrial revolution. Even with technology advances the blast furnace currently still requires around 800 kg of metallurgical coal for every tonne of iron produced and emits high levels of CO₂, roughly 1.8-2.0 t CO₂ per tonne of hot metal.

The use of fossil fuels, in particular the requirement for coal (in the form of coke), is an essential feed material for a blast furnace to operate, and it is not possible to simply use hydrogen therein as a complete substitute.

An alternative approach to blast furnaces is the direct reduction of iron ore in the solid state by carbon monoxide and hydrogen derived from natural gas or coal. While such plants are (outside of India) minor in number compared to blast furnaces there are many processes for the direct reduction of iron ore. In India coal based rotary kiln furnaces are used to produce DRI, also known as sponge iron (approaching 20% of world production of DRI), while elsewhere they tend to be gas based shaft furnace processes (approaching 80% of world production of DRI). The gas-based direct reduction plants are usually part of integrated steel mini-mills, located adjacent to the electric arc furnace (EAF) steel plant, but some DRI is shipped from captive direct reduction plants (usually Midrex™ or HYL™ process based) to remote steel mills. Because the DRI is used in electric arc furnaces, there are strict requirements on the levels of impurities in the DRI such as gangue and phosphorus which are expensive and difficult to remove in the EAF. Hence, the iron ores used to make DRI are often crushed and ground to micron particle sizes to enable removal of gangue minerals.

Such fine material is difficult to handle (both transport and operationally wise). Therefore, the fine material is agglomerated using water and/or binder to produce closely sized ‘green’ balls which are, once dried, then fed into furnaces where the ‘green’ balls are fired into hard pellets (a process known as induration), before eventually being supplied to direct reduction plants as feed material (or sometimes to blast furnaces as a high quality iron ore feed material to help dilute the gangue of the lump or sinter iron ore that a blast furnace uses). The ‘green’ balls that form the pellets have a typical compressive strength of around 10 N when wet, and 50 N when dried. As pellets (after induration), they have a compressive strength of around 2000 N.

One futurist alternative to all of the above is the production of DRI using hydrogen from iron ores (in the form of an indurated pellet feed) followed by smelting in an EAF to produce steel.

For this route to be carbon neutral, it requires conversion of renewable (green) energy into hydrogen (particularly in periods when wind/solar power cost is low), with subsequent production of DRI using the hydrogen. This route has strong support in Europe and has the potential to become a significant part of the global solution (1). However, there are limitations, as follows.
1. The amount of electricity needed is high (estimated at 3500-4500 kWh/t to the liquid steel stage) and green power cost needs to be low (or alternatively a high carbon tax needs to be in place) for it to become cost-effective against coal and natural gas-based processes.
2. Hydrogen consumption requirements for the production of DRI are likely to be steady, whilst the production of hydrogen itself is likely to be periodic in line with the availability of renewable energy, like wind and solar. This calls for a buffering approach to balance supply and demand. Storage and delivery of large amounts of hydrogen is a technical challenge. Underground salt caverns and exhausted natural gas reservoirs appear to show good potential. However, not all geographical locations may be amenable to this type of hydrogen storage. Moreover, suitable storage locations may not be close to DRI facilities for existing EAF steel mills and/or integrated steelmaking facilities, resulting in supply challenges.
3. Only low-gangue ore types (or those able to readily be upgraded to remove gangue) can be used with the DRI/EAF combination. The EAF will penalise high gangue ore types strongly, rendering them essentially non-competitive. This implies much of the ore currently used in blast furnaces could become sub-economic for such a process route.

It is known that biomass could be a complementary part of a sustainable solution, acting as a substitute for fossil fuels. Burning of either fossil fuels or biomass will release CO₂ when used. However, when fast growing plants are the source of the biomass, they are largely a carbon-neutral energy source, as through photosynthesis around the same amount of CO₂ is taken up when the plants are regrown.

To date there is no large-scale commercial ironmaking process that uses biomass directly, including for the DRI production route. Previous attempts to insert some biomass into processes originally designed for coal (e.g. blast furnaces and coke ovens) are marginal at best, typically relying on a pre-charring step for the biomass and usually quite disappointing in terms of overall CO₂ impact. This is largely because the nature of biomass is vastly different to that of coal. To use biomass successfully it is necessary to re-design the process around the fundamental nature of biomass.

Biomass can take many forms and avoiding competition with food production is key for biomass selection. Examples of biomass that might meet the selection criteria include elephant grass, sugar cane bagasse, wood waste, excess straw, azolla and seaweed/macroalgae. Such biomass availability varies considerably from one geographic location to another—and will most likely be a significant factor in determining the size and location of future biomass-based iron plants given the volume of material required and the economic challenges in transporting such material long distances.

Biomass such as wood chips have been shown in lab-scale studies (2) to be able to reduce iron ore to solid iron by the intermingling thereof with iron ore and placing in a furnace that heats the ore up to over 800° C. within a controlled atmosphere that prevents re-oxidation of the reduced material. While intermingling assists with the efficacy of the reduction process, on an industrial scale as a continuous process it potentially creates challenges, where gas flow created as part of the reduction process picks up fine particles of char, leading to massive gas processing/char recycling challenges, or a lot of carbon being wasted through the need to clean up the off-gases of the process, before discharge to the atmosphere.

Another example (described from laboratory phase experiments) is disclosed in AU 2007227635 B2 in the name of Michigan Technological University. The patent discloses the use of briquettes (for example, in the shape of coherent spherical balls) produced by mixing iron ore concentrate comprising magnetite (Fe₃O₄), wood chips that have passed through a 4.75 mm sieve, a small amount of flour, and slight moistening (to achieve agglomeration).

The patent discloses that the composites produced by the mixing step were dried at 105° C. (to provide strength and rigidity) in handling. The composites were then placed in a furnace (that was electrically heated) at temperatures in excess of 1375° C. to undertake the reduction of the iron ore. The patent discloses that preferably fine iron ore particles should be used and that while ‘particles as large as 0.25 inch in diameter’ (i.e. the typical top size of iron ore fines, being 6.35 mm) ‘or larger could be used, processing times would be unnecessarily long, and particles would not lend themselves to being formed into a coherent mass’.

The application of electromagnetic energy, such as microwave (MW) energy and radio frequency (RF) energy in iron ore reduction processes, whether as simply a form of heating energy or as a means to enhance reaction rates or provide additional heating at crucial times in the reaction process, to produce DRI has also been considered.

One of the first laboratory attempts known to the applicant is described in U.S. Pat. No. 4,906,290 assigned to Wollongong Uniadvice Limited. The patent discloses that briquettes containing a mixture of iron ore fines, coal and burnt lime were subjected to microwaves until they glowed red and were then placed in a crucible where they were smelted to produce a molten iron containing 3.8% carbon. While no examination of the microwave product from the microwaving is disclosed in the patent, the applicant suspects that it is likely that DRI was produced.

Another attempt in a laboratory where both MW energy and/or RF energy was applied to iron ore reduction is set out in US 2009/0324440 A1 assigned to Anglo Operations Limited.

Although perhaps more focused on ways to process titaniferous (i.e. ilmenite) type material, which would first be pre-oxidised to enhance reactivity (by the burning of any available fuel, including biomass, in an oxygen rich environment to facilitate such oxidation), it does disclose the reduction of hematite type iron ore in a fluidised bed reactor under atmospheres of solely H₂ (at temperatures between 400° C. and 600° C.) or CO (at temperatures between 600° C. and 800° C.) with or without the presence of MW energy or RF energy. The tests with such energy showed enhanced reaction rates, without any significant additional heating from the application of such energy.

Another attempt (also laboratory based) to enhance reaction rates or provide additional heating at crucial times in the reaction process, to produce DRI is described in International application PCT/AU2017/051163A in the name of the applicant. The application describes an invention of a process and an apparatus for direct reduction of iron ore in a solid state wherein briquettes of iron ore fragments and biomass are passed through a preheating chamber where they reach at least 400° C. before entering a heating/reduction chamber that is under anoxic conditions with biomass as a reductant and with electromagnetic energy as a source of energy. The disclosure in the International application is incorporated herein by cross-reference.

Thus, various lab-scale studies have shown that iron ores mixed with biomass and heated in a small furnace can produce DRI in a manner that appears (superficially) somewhat better than that expected from first principles. Likewise, the use of electromagnetic energy in such iron ore reduction processes has been shown to be advantageous. The technical challenge remains how to perform this efficiently at large scale.

The applicant has carried out further development work into the invention described in the International application PCT/AU2017/051163A to better establish how to perform the invention at scale in an efficient manner.

The above discussion is not to be taken as an admission of the common general knowledge in Australia or elsewhere.

### SUMMARY OF THE DISCLOSURE

The present invention is based on a realisation that “recycling” heat within a linear hearth furnace to the extent possible is important when a linear hearth furnace is used to produce direct reduced iron (DRI) with biomass as the main reductant and as a significant heating source of iron ore to be reduced.

In particular, the present invention is based on a realisation that an endless conveyor transporting briquettes through the furnace from an inlet (briquette feed) end and an outlet (DRI discharge) end and then returning to the inlet end is an opportunity to capture and “recycle” a significant amount of heat within a linear hearth furnace at a hot reduction end, i.e. a DRI discharge end, of the furnace.

In general, the term “linear hearth furnace” typically describes a furnace that includes a lengthwise extending thermally-insulated, typically refractory-lined, heating chamber with an inlet (feed) end at one end and an outlet (discharge) end at the opposite end and an endless conveyor that extends along the length of the chamber and carries material through the chamber from the inlet to the outlet ends for thermal processing in the chamber, with the conveyor returning to the inlet end from the discharge end and repeating the process of loading material on the conveyor to be transported through the chamber.

Typically, material on the conveyor is subjected to conventional heating as it is transported through the furnace, with conventional heating including heating by one or more than one of convection, conduction and/or radiation processes to provide thermal processing, typically rapid thermal processing. For material that by its nature has a tendency to naturally flow when stacked, it is usual to place such material on segments (separate from each other or interlinked) that form a base that is moved through the furnace, rather than seeking to periodically lift/push the material itself in a manner that causes it to move through the furnace (as may be done with say steel billets or slabs). However, because the material transported in this way is in a static position on the moving segments, it is usually the case that there is a marked temperature gradient through such material, i.e. the material is unlikely to have sufficient time (often called ‘soaking’ time) for it to have an essentially uniform temperature, with the material facing upmost to the conventional heating means in the chamber of the furnace receiving the most heat and the material closest to the moving segments receiving the least heat. Such a temperature gradient can be significant when dealing with temperature dependent processes and can be intensified by any stacking of material, that by its nature thereby constrains the conduction of heat.

In order to address this, one option is to select a comparatively slow speed of travel of the material on the moving and/or use a comparatively shallow bed depth of the material.

Regardless, this is not necessarily a viable solution because it means an overall reduction in the productivity of the desired process and can seriously impact process economics.

In broad terms, the present invention provides a method and an apparatus for “recycling” a significant amount of heat within a linear hearth furnace by means of an endless conveyor that transports briquettes through the furnace from an inlet (briquette feed) end to an outlet (DRI discharge) end and then returns to the inlet end and transfers a significant amount of heat from the outlet end to the inlet end of the furnace.

More particularly, the invention provides a method for producing direct reduced iron (DRI), typically continuously, from briquettes of a composite of iron ore fragments and biomass in a linear hearth furnace as described below including a chamber having the following zones along the length of the furnace between an inlet for briquettes of iron ore fragments and biomass and an outlet for direct reduced iron: a feed zone that includes the inlet, a preheat zone, a final reduction zone and a discharge zone that includes the outlet, and an endless conveyor that is movable through the zones, with the conveyor having a base for receiving and supporting briquettes and ultimately DRI, the method including:
a) feeding briquettes onto the base of the conveyor in the feed zone, for example as the conveyor moves through the feed zone;
b) transporting briquettes on the conveyor through the preheat zone and heating briquettes and reducing iron ore in briquettes and releasing volatiles in biomass in briquettes, with heating including generating heat by burning combustible gases in a top space of the preheat zone via a plurality of air or oxygen-enriched air fed burners, with the combustible gases including combustible gases originating within the furnace;
c) transporting heated briquettes on the conveyor from the preheat zone through the final reduction zone, with the final reduction zone being an anoxic environment, and supplying electromagnetic energy, such as microwave energy, into the final reduction zone and heating briquettes and reducing iron ore in briquettes and forming DRI;
d) transporting DRI on the conveyor to the discharge zone at the outlet and discharging DRI from the discharge zone; and
e) returning the unloaded conveyor from the outlet to the inlet of the furnace and repeating step (a) of feeding briquettes onto the base of the conveyor, with the base of the conveyor having a hot face temperature of at least 500° C. when it returns to the feed zone and before it is loaded with briquettes and thereby returning heat to the furnace and contributing to heating briquettes.

The term “linear heath furnace” is understood herein to mean a furnace that extends horizontally in a straight line and has a thermally insulated, such as refractory-lined, chamber having the following zones along the length of the furnace between an inlet for iron ore and biomass and an outlet for direct reduced iron: a feed zone that includes the inlet, a preheat zone, a final reduction zone and a discharge zone that includes the outlet, and an endless conveyor that moves through the zones from the inlet to the outlet and then returns to the inlet, with the conveyor having a base for receiving and supporting briquettes.

The term “endless conveyor” is understood herein to mean any type of conveyor that is configured to move in an endless path. In the case of an endless conveyor for a linear hearth furnace, the conveyor moves in a linear forward path from the inlet to the outlet of the furnace and in a return path that brings the conveyor back to the furnace inlet.

The term “base of the conveyor” is understood herein to mean an upwardly facing surface that is configured to receive and support briquettes on the surface. The base may be continuous. The base may be not continuous and, for example, may be in the form of a series of trays that are separate from each other or interlinked (and separable, if required).

The conveyor may have a segmented base for receiving and supporting briquettes and ultimately DRI.

The term “segmented base” is understood herein to mean any form of base that includes a plurality of segments that are separate or connected together to allow the base to move in an endless path. Without in any way limiting, each segment may be an individual tray or plate (whether of metal, refractory material or a blend of both).

The term “anoxic” is understood herein to mean substantially or totally deficient in oxygen.

The term “briquette” is understood herein as a broad term that means a composite of iron ore fragments and biomass in which the iron ore fragments and biomass have been brought into close contact through compaction, or alternatively through mixing and binding, of the iron ore and biomass together. Those skilled in the art would typically describe the latter (particularly when in a spherical form) as pellets. While the inventors believe “green” pellets have some inherent challenges, not least being they usually need to be carefully dried first (thereby avoiding any sudden steam evolution) and any chosen binder used cannot be one where massive instantaneous devolatilization occurs during heating—both events potentially leading to structural failure of the pellet; pellets are not excluded, but the term briquette does not include indurated pellets, as a feed material according to the method, as such pellets basically get their increased compressive strength by oxidation of the iron ore fragments at temperature back to a higher state of oxidation and through sintering with at least some cross bonding between such fragments. As such, they cannot contain biomass (at least not in a uncarbonized form, i.e. any residual carbon remaining could only be there simply as a function of oxidation reactions not being provided with sufficient time to reach equilibrium).

The term “fragment” is understood herein to mean any suitable size piece of iron ore (as passed through an appropriately screen mesh of 6.35 mm spacing or below) and as used herein may be understood by some persons skilled in the art to be better described as “particles” and/or “fines”. The intention herein is that such terms be used as synonyms. The iron ore may be any suitable type such as magnetite, hematite and/or goethite. However, it does not preclude other iron rich ores from which iron may be extracted such as limonitic laterites, titaniferous magnetite and vanadiferous magnetite due to the local unavailability of the more usual forms of iron ore from which iron is traditionally extracted.

The term “biomass” is understood herein to mean living or recently living organic matter. Specific biomass products for a composite of iron ore fragments and biomass include, by way of example, forestry products (in the form of woodchips, sawdust and residues therefrom), agricultural products and their by-products (like sorghum, hay, straw and sugar cane bagasse), agricultural residues (like almond hull and nut shells), purpose grown energy crops such as Miscanthus Giganteus and switchgrass, macro and micro algae produced in an aquatic environment, as well as recovered municipal wood and paper wastes.

Step (a) of the method may include forming a relatively uniform bed of briquettes on the conveyor.

The term “relatively uniform bed of briquettes” is understood herein to mean a relatively uniform layer of briquettes on the base of the conveyor and typically having a consistent ‘bed’ depth, at least length ways, i.e. in the direction of briquette travel within the furnace. This does not however mean that individual briquettes have to be stacked in anything more than a random way on the base.

The hot face temperature of the unloaded base of the conveyor in the feed zone before it is loaded with briquettes in the feed zone may be at least 550° C. so as to recover heat therefrom.

The hot face temperature of the unloaded base of the conveyor in the feed zone before it is loaded with briquettes in the feed zone may be at least 600° C. so as to recover heat therefrom.

The hot face temperature of the unloaded base of the conveyor in the feed zone before it is loaded with briquettes in the feed zone may be at least 700° C. so as to recover heat therefrom.

The hot face temperature of the unloaded base of the conveyor in the feed zone before it is loaded with briquettes in the feed zone may be at least 800° C. so as to recover heat therefrom.

The method may include returning the conveyor to the inlet through a thermally-insulated, such as refractory-lined, chamber in a lower region of the furnace which extends along the length of the furnace between the inlet and the outlet to maintain heat or minimise heat loss in the base of the conveyor between the outlet and the inlet of the furnace.

The method may include heating the lower region of the furnace and therefore the base of the conveyor, for example using hot gases from the furnace.

The method may include heating the base of the conveyor by transferring at least a part of hot gases produced by combusting combustible gases in the preheat zone to the lower region of the furnace.

The method may include heating the base of the conveyor by transferring at least a part of hot gases produced in the final reduction zone to the lower region of the furnace.

The method may include heating the base of the conveyor by electrical elements. The electrical elements may be powered by ‘green’ energy.

The mass percentage of biomass in briquettes may be 20-45%, typically 30-45%, by weight on a wet (as-charged) basis.

The biomass may include a significant lignocellulosic component.

The biomass may include a lignocellulosic component that is at least 5% by weight of the mass of the biomass.

The balance of the composition of briquettes may be (a) iron ore fragments (b) optionally flux/binder materials and (c) optionally additional carbonaceous material, such as coal or pre-charred biomass, in an amount of <5% by weight of the total weight of individual briquettes.

The method may include controlling the method so that the bulk temperature of briquettes is at least 500° C., typically at least 550° C., more typically at least 600° C., when briquettes leave the preheat zone and pass to the final reduction zone.

Step (c) of the method may include electromagnetic energy heating briquettes and increasing the temperature of briquettes by at least 250° C., typically at least 300° C., in the final reduction zone.

The method may include releasing at least 90%, typically at least 95%, of volatiles in biomass in the briquettes as a gas in the preheat zone.

The method may include generating heat in step (b) by burning combustible gases, including combustible gases generated within the furnace, in a plurality of burners that are spaced apart along the length of the top space of the preheat zone of the furnace.

The method may include generating heat in step (b) by burning combustible gases in a plurality of burners that are spaced across the width of the preheat zone of the furnace.

The method may include adjusting the amount of air or oxygen-enriched air fed to each burner in step (b) to compensate for variations in combustible gas in the top space of the preheat zone.

The method may include supplying preheated air or preheated oxygen-enriched air to the burners in step (b).

The term “burner”, while not limited hereto, is understood to mean any suitable apparatus that facilitates a flame of burning gases being formed beyond its tip under operating conditions. It is not limited to apparatus in which flammable gases are fed thereto. As such it may also be described as a ‘air lance’ or ‘oxygen lance’.

To achieve a preferred outcome of releasing a majority of volatiles as a gas from the biomass within heated briquettes prior to briquettes leaving the preheat zone (potentially qualitatively measured through the amount of hydrogen in the gas stream passing at that location point), the finish preheat temperature for the briquettes (as a collective term as briquettes leave the preheat zone, i.e. a bulk temperature) may be in a range of 500-800° C., and more typically at least 600° C. and up to 800° C. Because of the nature of a bed of briquettes, the temperature throughout the bed will not be uniform and can be expected to vary through the bed and across the bed. While an individual briquette in a laboratory setting, i.e. a small sample under closely controlled heating conditions will have had its biomass pyrolysis (i.e. devolatilisation) mostly completed by 400° C., in a furnace with a moving bed (and with variations caused by bed depth and the like) this process cannot be taken for granted without the bulk temperature being at least 500° C., and preferably 600° C. for complete assurance.

The term “volatiles” is usually understood to mean gases, other than those arising from water (whether bound or free) being initially driven off, that are formed or released by heating of biomass which causes breakdown of organic components as gases.

Unlike the position with coal, the inventors are not aware of an industry standard for measuring volatiles in biomass. For coal, volatiles (volatile matter) is measured as a weight percentage of gas (emissions) from the coal sample that is released during heating to, typically, 950° C. in an oxygen free environment, except for moisture (which will evaporate as water vapor) at a determined standardization temperature. The inventors believe that it is desirable for low-boiling-point organic compounds that will condense into oils on cooling to not be generally present in the residual biomass that passes into the final reduction zone, where such compounds have the potential to interfere and/or interact unfavourably with the electromagnetic system.

Accordingly, the term “volatiles” is understood herein to mean only low-boiling-point organic compounds that are driven off at temperatures below 600° C. upon heating in an oxygen free environment.

Typically, the method includes supplying briquettes at ambient temperature to the preheat zone of the furnace and progressively heating briquettes to a finish preheat temperature as briquettes are transported through the preheat zone on the conveyor.

The method may include controlling the method so that at least 90%, typically at least 95%, of volatiles in biomass in the briquettes is released as a gas in the preheat zone.

The control options for achieving volatilisation mentioned in the preceding paragraph include controlling, by way of example, any one or more than one of the temperature profile in the furnace, the residence time of briquettes in the preheat zone, the length of the preheat zone, the travelling speed of the conveyor, the briquette loading on the conveyor, and the amount of biomass in the briquettes, noting that a number of the factors are inter-related.

By way of example, the travelling speed i.e. velocity, of the conveyor, may be controlled so as to give briquettes sufficient time in the preheat zone for at least 90%, typically at least 95%, of the volatiles to be released from biomass in briquettes.

The travelling speed may also be controlled so that heating briquettes in the final reduction zone using electromagnetic energy alone increases the temperature of briquettes by at least a further 250° C., and typically at least 300° C.

It is noted that travelling speed is not the only factor relevant to achieving the at least 250° C. temperature increase of briquettes in the final reduction zone. Other factors include controlling, by way of example, any one or more than one of the residence time of briquettes in the final reduction zone, the length of the final reduction zone, the briquette loading on the conveyor, the type and power of the electromagnetic energy, noting that a number of the factors are inter-related.

The briquettes may be any suitable size and shape. Typically, a briquettes size is defined by its ‘matrix size’ which is the nominal volume of the briquette formed by filling the cavity within the moulds/rolls when they come completely together. A typical cavity for a briquette of 5 cm³ matrix size would have the dimensions 30 mm long by 24 mm wide by 17 mm high (at their maximum lengths) with rounded edges/corners. In the case of ‘compacted’ briquettes their actual volume will be larger than the matrix size as the mould/rolls do not in practice come together due to an excess of material being fed to ensure complete compaction within the void, i.e. the matching moulds/rolls creating the cavities for forming the briquettes are held apart from each other by such excess material. There is also usually expected to be some natural spring back of the compacted material upon release from the moulds/rolls.

By way of example, the briquettes may have a volume of less than 25 cm³ and greater than 2 cm³. Typically, the briquettes may have a volume of 3-20 cm³.

By way of example, the briquettes may have a major dimension of 1-10 cm, typically 2-6 cm and more typically 2-4 cm.

By way of example, the briquettes may be generally cuboid, i.e. box-shaped, with six sides and all angles between sides being right angles. By way of example, the briquettes may be “pillow-shaped” briquettes. By way of further example, the briquettes may be “ice hockey puck-shaped” briquettes.

The briquettes may include any suitable relative amounts of iron ore and biomass. The briquettes may include 20-45% by weight on a wet (as-charged) basis, typically 30-45% by weight on a wet (as-charged) basis, of biomass. When choosing to use compacted briquettes ideally the biomass is chosen so that it has a significant lignocellulosic component within.

In any given situation, the preferred proportions of the iron ore fragments and biomass will depend on a range of factors, including but not limited to the type ore (e.g. hematite, goethite or magnetite) and their particular characteristics (such as fragment size and mineralogy), the type and characteristics of the biomass, the operating process constraints, and materials handling considerations.

The DRI on exiting the final reduction zone may be at a bulk temperature of at least 900° C., typically at least 1000° C., and more typically at least 900° C. to up to 1150° C., from the further heating by electromagnetic energy.

Typically, the DRI on exiting the final reduction zone is in the bulk temperature range of 900 to 1000° C.

The use of the term “final reduction zone” does not preclude all or a majority of the iron ore reduction occurring in that zone. Likewise, the use the use of the term ‘preheat zone’ does not of itself preclude some reduction of iron ore actually occurring therein.

Step (c) of the method may include generating a higher pressure of gases in the final reduction zone compared to gas pressure in the preheat zone and thereby causing gases generated in the final reduction zone to flow counter-current to the direction of movement of briquettes on the conveyor through the furnace.

The method may include generating the higher pressure in the final reduction zone as a consequence of reduction of iron ore in briquettes in the final reduction zone generating gases in the zone, noting that the gas generation also contributes to creating and maintaining the anoxic environment.

The method may include generating the higher pressure in the final reduction zone by supplying an inert gas, such as nitrogen, or any other suitable gas into the final reduction zone, noting that the gas injection also contributes to creating and maintaining the anoxic environment.

The method may include creating the higher pressure in the final reduction zone by means of a gas flow “choke” in the reduction zone.

The gas flow “choke” in the reduction zone may be configured to increase the gas velocity of gases generated in the final reduction zone from the reduction zone to the preheat zone by a factor of 2-3 compared to what the gas velocity would have been without the gas flow “choke” in order to ensure that there is no substantial gas flow from the preheat zone to the final reduction zone of the furnace.

The invention is not necessarily confined to a particular electromagnetic energy.

The current focus of the applicant is on the microwave energy band of the electromagnetic energy spectrum.

Radio frequency energy however is another option amongst the range of options in the electromagnetic energy spectrum of interest to the applicant.

A key requirement however is that the furnace be designed so that the energy is contained within the furnace.

The microwave energy may have any suitable microwave frequency and vary by country, but the current industrial frequencies of around 2450 MHz, 915 MHz and 443 MHz are of most interest.

The radio frequency energy may be any suitable frequency, such as in the range of 1 MHz-10 GHz.

As noted above, the briquette heating in step (b) may include generating heat by burning combustible gases generated in the furnace via the plurality of air or oxygen enriched air fed top space burners, typically preheated air or oxygen enriched air fed top space burners, within the preheat zone.

Typically, step (b) includes combusting at least 85% by volume, more typically at least 90%, and more typically at least 90%, of combustible gases generated in the furnace.

The burners may be either (i) spaced along the top of the oven chamber or (ii) aligned more or less horizontally along the long axis to assist in ensuring a generally uniform heating pattern along the length of the preheat zone and to achieve direct radiant heat transfer from the top of the chamber.

The amount of preheated air or oxygen enriched air fed to each burner may be adjusted to compensate for established variations in fuel gas flow across and along the chamber.

In use, combustible gases in the hot gas flowing into the preheat zone from the final reduction zone combust as the gases passes each of the plurality of air or oxygen enriched air fed top space burners.

The combustion profile, i.e. the profile of post-combustion of combustible gas along the length of the preheat zone, may be 35-45% at a hot end of the preheat zone, i.e. at the end adjacent the final reduction zone, at least 75% and approaching 90-95% at a cold end of the preheat zone, i.e. at the end adjacent the feed zone. The combustion profile may be any suitable profile.

Post combustion (PC) is defined herein as:

PC %=100×(CO₂+H₂O)/(CO+CO₂+H₂+H₂O),

where the symbol for each species (CO, CO₂ etc) represents the molar concentration (or partial pressure) of that particular species in the gas phase.

In simple terms, PC is a measure of the combustion of combustible gas, with zero indicating no combustion and 100% indicating fully combusted.

It follows from the preceding paragraphs that the above combustion profile maintains the preheat zone top space in a bulk reducing condition along the length of the preheat zone, with feed oxygen being consumed rapidly in a vicinity of each burner (in a small localised region).

The method may include discharging gas produced in the furnace by heating and/or combustion within the furnace as a flue gas through a flue gas outlet close to the feed zone.

The method may include processing the flue gas in a flue gas system before discharging the processed flue gas to the atmosphere.

The method may include recovering heat from the flue gas and using the heat for preheating air to the burners in the preheat zone.

By way of example, gas discharged from the preheat zone via the flue gas outlet is typically ducted (hot, around 1100-1300° C.) to an after burning chamber where there is final combustion of combustible gas in the flue gas and consequential heat generation.

Step (e) of the method may include discharging DRI from the discharge zone via the outlet into a vessel that is configured to restrict substantial ingress of oxygen-containing gases into the vessel.

Positive nitrogen gas streams can be used to assist in this process.

Step (e) may include discharging DRI from the discharge zone via the outlet and transporting the DRI in a hot state away from the furnace Another aspect of the inventive approach is the use of some form of vessel at the discharge point for the direct reduced iron (DRI) produced that can prevent the substantial ingress of oxygen into the furnace while it is receiving DRI. Positive nitrogen gas streams can be used to assist in this process.

Where the vessel is in part a container, that is exchanged on filling with a replacement container, it is preferred that such container remain sealed after filling. Without steps being taken to control the amount of oxygen available to the DRI, the oxygen will rapidly re-oxidise DRI and may become partially liquid.

One example of a vessel is a vessel that has (a) an opening to receive hot DRI, (b) forms an integral seal with the outlet of the furnace at least during filling the vessel, and (c) a closure that can close that opening after receiving the hot DRI. It is not necessary that the closure form an absolutely gas-tight seal with the section of the vessel that defines the opening, only that the closure be sufficient that it is sealed enough to restrict ingress of air that causes unacceptable levels of oxidation of DRI in the vessel. The skilled person will understand the requirements for the gas-tight seal. Positive nitrogen gas streams can be used to limit access of air into the vessel.

The invention also provides an apparatus for producing direct reduced iron (DRI), typically in a continuous manner, from briquettes of a composite of iron ore fragments and biomass, the apparatus including a linear hearth furnace that includes a refractory-lined chamber having:
(a) an inlet for briquettes of iron ore and biomass at one end and an outlet for direct reduced iron at the other end,
(b) the following zones:
   (i) a feed zone that includes the inlet for briquettes;
   (ii) a preheat zone for heating briquettes and reducing iron ore in briquettes and releasing volatiles in biomass in briquettes, the preheat zone including a plurality of air or oxygen-enriched air fed burners for generating heat by burning combustible gases in a top space of the preheat zone, with the combustible gases including combustible gases originating within the furnace,
   (iii) a final reduction zone for heating briquettes and reducing iron ore in briquettes and forming DRI, the final reduction zone including a means for supplying electromagnetic energy, such as microwave energy, into the final reduction zone for heating briquettes; and
   (iv) a discharge zone that includes the outlet, the discharge zone being configured for discharging DRI from the furnace; and
(c) an endless conveyor having a base for receiving and transporting briquettes through the zones from the inlet to the outlet and then returning to the inlet,

with the apparatus being configured to return the conveyor from the outlet to the inlet of the furnace with the base having a hot face temperature of at least 500° C., typically at least 500° C., and more typically at least 600° C., when it returns to the feed zone and before it is loaded with briquettes and thereby recovering heat from the furnace and then returning heat to the furnace and contributing to heating briquettes.

The conveyor may include a return leg that extends through a thermally-insulated chamber in a lower region of the furnace that is configured to maintain heat or minimise heat loss in the base of the conveyor between the outlet and the inlet of the furnace.

The conveyor may include a return leg that extends through a thermally-insulated chamber in a lower region of the furnace that can be heated by heated combustion gases from the furnace.

Alternatively, heating by electrical elements could be used. The electrical elements may be powered by ‘green’ energy.

The apparatus may be configured to generate a higher pressure of gas in the final reduction zone compared to gas pressure in the preheat zone to cause gases generated in the final reduction zone to flow counter-current to the direction of movement of briquettes on the conveyor through the furnace.

The apparatus may include a flue gas outlet in the preheat zone for discharging gas produced in the furnace that flows in the counter-current direction to the outlet.

The apparatus may include an afterburning chamber for combusting combustible gas in the gas discharged via the flue gas outlet.

The invention also provides direct reduced iron (DRI) produced by the above-described method.

The invention also provides direct reduced iron (DRI) produced by the above-described apparatus.

### BRIEF DESCRIPTION OF THE DRAWINGS

The present invention is described further by way of example with reference to the accompanying drawings, of which:

FIG. 1 is:
(a) a schematic diagram of one embodiment of an apparatus for producing direct reduced iron (DRI) from briquettes of a composite of iron ore fragments and biomass in accordance with the invention,
(b) a temperature profile along the length of the furnace of the apparatus of FIG. 1 for an embodiment of a method for producing direct reduced iron (DRI) from briquettes of a composite of iron ore fragments and biomass in accordance with the invention, and
(c) a plot of off-gas volumetric flow rate of gas produced along the length of the furnace during the course of the method;

FIG. 2 is a flowsheet diagram illustrating one embodiment of a method for producing direct reduced iron (DRI) from briquettes of a composite of iron ore fragments and biomass in accordance the invention in the apparatus of FIG. 1; and

FIGS. 3 and 4 are schematic diagrams of another, although not the only other, embodiment of an apparatus in accordance with the invention, with FIG. 3 showing a vertical cross-section and FIG. 4 showing a transverse cross-section of the apparatus diagrammatically shown in these Figures.

### DESCRIPTION OF EMBODIMENTS

As noted above, in broad terms, the present invention is a method and an apparatus for producing direct reduced iron (“DRI”) from briquettes of a composite of iron ore fragments and biomass that includes transporting briquettes through, typically continuously through, a furnace having an inlet for briquettes and an outlet for DRI and a feed zone, a preheat zone, a reduction zone, and a discharge zone between the inlet and the outlet.

FIG. 1 is a schematic diagram of an embodiment of an apparatus of the present invention in the form of a linear hearth furnace.

The invention is not confined to a single linear hearth furnace and, by way of example, may extend to two linear hearths working in tandem. i.e. where an endless conveyor passes through both. The invention extends to other arrangements.

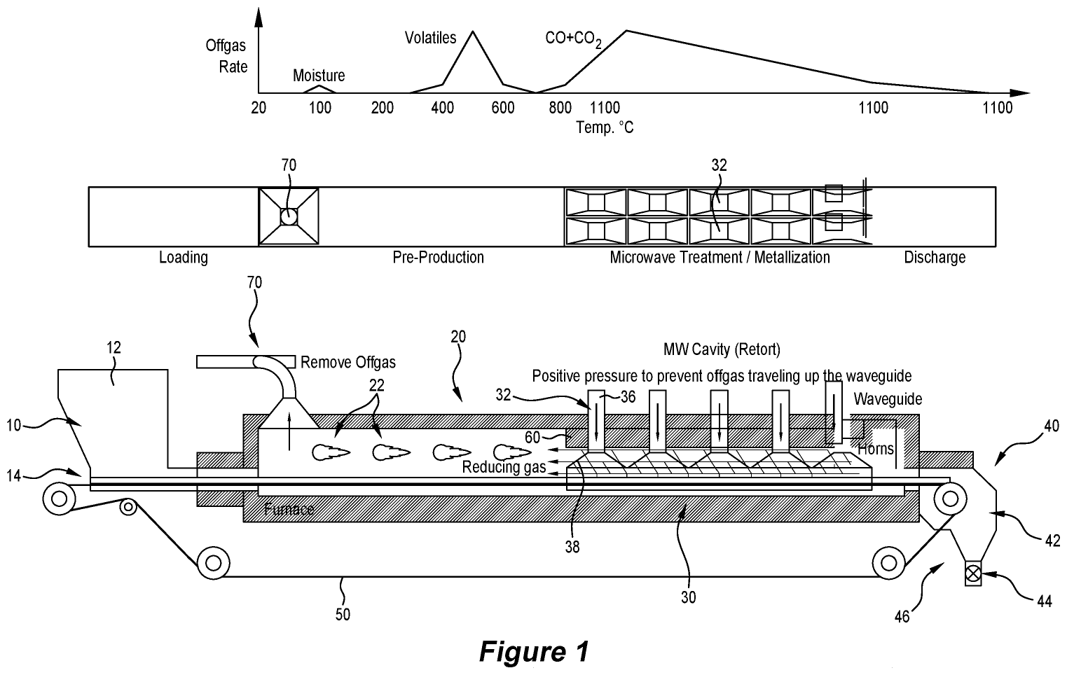

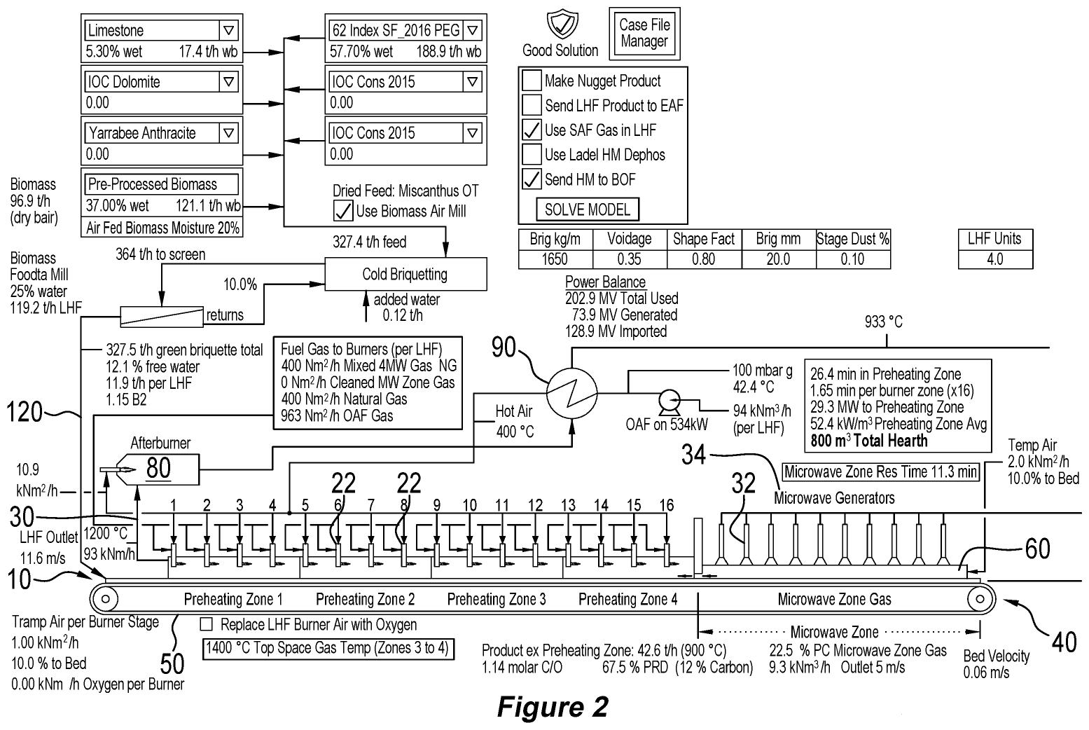

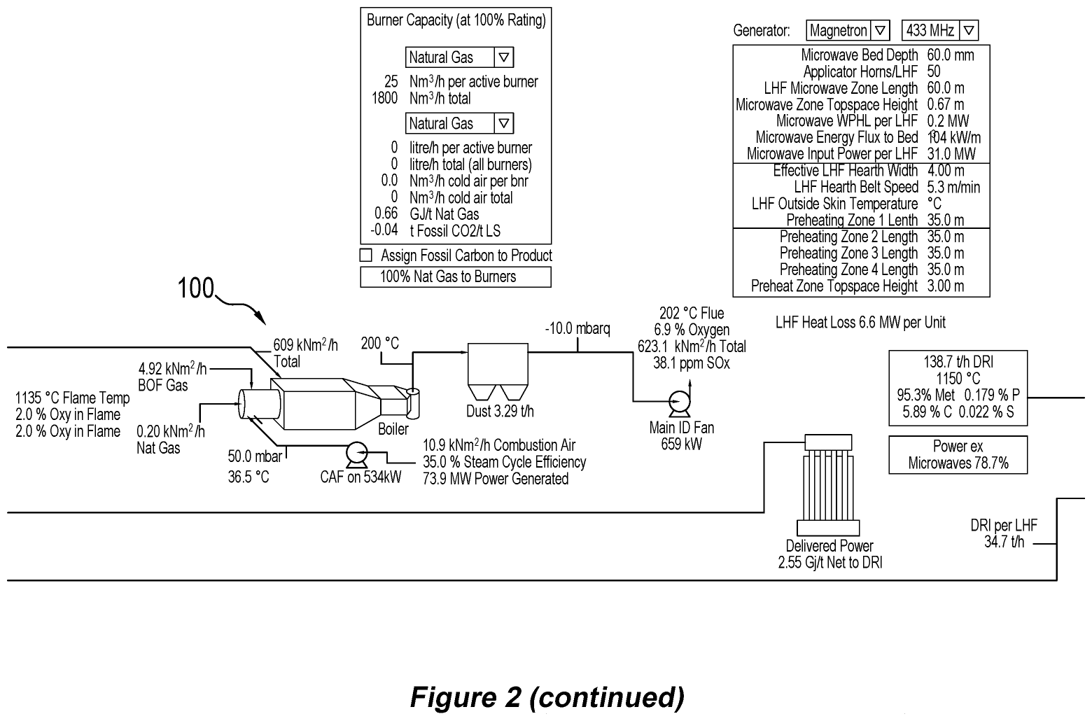

With reference to FIG. 1, the furnace, generally identified by the numeral 3, includes an elongated thermally-insulated, typically refractory-lined, chamber that has the following zones along its length:
(a) a feed zone 10 that includes an inlet 14 to the chamber and is configured to receive briquettes 120 (see FIG. 2) of iron ore and biomass,
(b) a preheat zone 20 for heating briquettes and reducing iron ore in briquettes and releasing volatiles in biomass in briquettes as a gas, with the volatiles being combusted in the preheat zone,
(c) a final reduction zone 30 for heating briquettes and reducing iron ore in briquettes and forming DRI;
(d) a discharge zone 40 that includes an outlet 46 of the chamber and is configured to discharge DRI,
(e) an endless conveyor 50 having a refractory or metallic material base that moves through the chamber, typically continuously, from the inlet to the outlet and transports briquettes through the chamber from the inlet and discharges DRI from the outlet and then returns to the inlet to be re-loaded with briquettes; and
(f) a flue gas outlet 70 in the preheat zone 20 for discharging gas produced in the furnace by heating and/or combustion within the furnace.

The feed zone 10 is configured in this embodiment to continuously feed briquettes 120 into the feed zone 10 via the inlet 14 to form a relatively uniform bed of briquettes on the moving conveyor 50 in the feed zone 10 of the chamber, while restricting outflow of furnace gases via the inlet 14. The feed zone 10 includes a feed chute 12 that can receive and direct briquettes 120 onto the conveyor 50.

The discharge zone 40 is configured to continuously discharge DRI from the discharge zone 40 via the outlet, while restricting the inflow of oxygen-containing gases into the final reduction zone 30 of the chamber. The discharge zone 40 includes an enclosed discharge chute 42 that has a downwardly-directed outlet 46 that has a flow control valve 44 that can be selectively operated to allow DRI to flow through the outlet 46.

The furnace may have any suitable dimensions.

The relative lengths of the feed zone 10, the preheat zone 20, the final reduction zone 30, and the discharge zone 40 may be selected as required having regard to the iron ore and biomass in the feed briquettes, the required characteristics (such as metallisation) of the DRI product, and the required operating conditions in the furnace.

The preheat zone 20 has a plurality of air or oxygen-enriched air fed burners 22 for generating heat by burning combustible gases in a top space of the preheat zone 20. The burners 22 are spaced along the length and across the width of the preheat zone 20. The optimal spacing can be readily determined by a skilled person for any given operating conditions, such as the amount and type of biomass and the amount and type of iron ore in the feed briquettes and the required metallisation and other characteristics of the DRI product. The spacings along the length and across the width may be constant or may vary depending on the operating requirements for the furnace.

The combustible gases generated in the furnace include combustible gases originating within the furnace. The combustible gases include:
(a) volatiles in biomass in briquettes moving through the preheat zone 20; and
(b) combustible gases, such as CO, generated by reduction of iron ore in briquettes in:
   (i) the preheat zone 20; and
   (ii) the final reduction zone 30, with the combustible gases generated in the final reduction zone 30 flowing from the final reduction zone 30 to the preheat zone 20, as described further below.

There may be additional combustible gases supplied to the burners 22 depending on the required operating conditions in the furnace.

In use, the final reduction zone 30 is maintained as an anoxic environment.

The final reduction zone 30 includes a plurality of electromagnetic energy input units 32 (including waveguides 36 and hoods 38) in a top space thereof for heating briquettes. The electromagnetic energy input units 32 are operatively connected to an electromagnetic energy generator 34 (see FIG. 2—in which the generator is a microwave energy generator).

FIG. 1 shows how the bulk temperature of briquettes and gases generated in the furnace in the described embodiment of the method vary (in a qualitative form) along the length of the furnace.

The bulk temperature of briquettes is contributed to in part by the amount of heat in the conveyor 50 that is retained when the conveyor 50 returns to the feed zone 10 and how much heat is then transferred to briquettes as briquettes move through the furnace.

In the described embodiment the apparatus is configured, and the method conditions are selected, so that the base of the conveyor 50 has a hot face temperature of at least 500° C., at typically least 550° C., and more typically at least 600° C., when the conveyor returns to and is in the feed zone 10. This retained, i.e. “recycled”, heat contributes to heating briquettes and therefore contributes to the bulk temperature of briquettes. The temperature of at least 500° C. is considered to be a minimum temperature to make a significant contribution to the heat requirements of the method/apparatus.

In use of the apparatus, gases generated in the final reduction zone 30 flow into the preheat zone 20 counter-current to the direction of movement of briquettes on the conveyor 50 through the furnace from the inlet to the outlet.

The counter-current flow of gas from the final reduction zone 30 into the preheat zone 20 is caused by a higher gas pressure in the final reduction zone 30 compared to gas pressure in the preheat zone 20.

The higher gas pressure is a result of several structural and operational factors in the described embodiments of the method and the apparatus of the invention.

One factor is that the transverse cross-sectional area of the final reduction zone 30 is less than that of the preheat zone 20. In this regard, the final reduction zone 30 includes an additional elongate upper wall section 60 that makes the height of the preheat zone 20 lower than that of the preheat zone 20.

Another factor is injection of nitrogen gas (or any other suitable gas) into the final reduction zone 30 which, in addition to contributing to generating and maintaining the higher pressure, contributes to generating the anoxic environment in the final reduction zone 30.

Another factor is the volume of gas generated via reduction of iron ore in the briquettes in the final reduction zone 30 which, in addition to contributing to generating and maintaining the higher pressure, contributes to generating the anoxic environment in the final reduction zone 30. The volume of reduction gas generated in the final reduction zone 30 is illustrated by the plot of off-gas volumetric flow rate along the length of the chamber shown in FIG. 1.

A final factor is a suction effect of an exhaust fan at the end of the off-gas train (heat exchanger 90 and boiler 100—see FIG. 2) connected to the flue gas outlet 70 of the furnace; which depending on its size may have a significant influence.

The counter-current flow of gas from the final reduction zone 30 to the preheat zone 20 transfers combustible gases, such as CO, that are generated in reactions that reduce iron ore in the final reduction zone 30 to the preheat zone 20. The combustible gases in the gas flow from the final reduction zone 30 are combusted by the plurality of air or oxygen-enriched air fed burners 22 spaced along the length and across the width of the preheat zone 20. The combustion profile may be 35-45% at a hot end of the preheat zone 20, i.e. at the end adjacent the final reduction zone 30, increasing to around 85-90% at a cold end of the preheat zone 20, i.e. at the end adjacent the feed zone 10.

The combustion of (a) combustible gases generated in the final reduction zone 30, (b) combustion of volatiles released from biomass in the preheat zone, and (c) combustion of combustible gases generated by reduction of iron ore in the preheat zone 20 provides an important component of the heat requirements for the method.

The temperature profile shown in FIG. 1 is an example of a suitable temperature profile along the length of the furnace. With reference to the Figure, the temperature in the furnace steadily increases in the feed zone 10 and the preheat zone 20 with distance from the inlet, with the temperature reaching 800° C. at the end of the preheat zone 20, noting that the temperature may be higher or lower in other embodiments depending on operational and DRI requirements, with a typical range of 600-900° C. The temperature remains substantially constant around 1100° C. in the final reduction zone 30, thereby allowing time for the required metallisation to be achieved, noting again that the temperature may be higher or lower in other embodiments depending on operational and DRI requirements.

In use, the conveyor 50 transports briquettes (not shown) successively and continuously through the zones 10, 20, 30, 40 in a sequential manner and eventually circles back in its endless path so that each portion of the refractory or metallic base material of the conveyor 50 eventually presents itself at the feed zone 10 to be loaded with more briquettes.

The refractory or metallic base material has residual heat from the chamber when the conveyor 50 returns to the feed zone 10 and this heat contributes to heating briquettes loaded onto the conveyor 50 in the feed zone 10. In other words, the conveyor 50 is a means of recycling heat of the furnace.

Depending on the selection of the materials and the size of the conveyor 50, the conveyor can recycle significant thermal mass to the furnace and make a significant contribution to heating briquettes in the feed zone 10. The above description refers to the conveyor 50 having a refractory or metallic material base. One particular option is a conveyor 50 with a lower section formed form a refractory material and an upper section formed from stainless steel or other heat conductive material.

In use, gases generated in the chamber are discharged as a flue gas via the flue gas outlet 70 in the preheat zone 20.

As described above in relation to the term “briquettes”, it is important for the invention that iron ore fragments and biomass be in quite close contact. Any approach to achieving this close contact may be used. Ore-biomass mixing followed by compaction of the materials to form briquettes between two rolls in which there are naturally aligning pockets, is one example. Alternative such compaction option is ore-biomass mixing followed by roll pressing using rolls without pockets into compressed slabs containing the iron ore fragments and biomass that break up naturally (or are deliberately broken up) prior to feeding into the feed station zone.

The briquettes may be manufactured by any suitable method. By way of example, measured amounts of iron ore fines and biomass and water (which may be at least partially present as moisture in the biomass) and optionally flux is charged into a suitable size mixing drum (not shown) such as a Eirich™ mixer and the drum arms rotated to form a homogeneous mixture.

Thereafter, the mixture may be transferred to a suitable briquette-making apparatus (not shown) and cold-formed into briquettes.

In one embodiment of the invention, the briquettes are roughly 20 cm³ in volume and contain 30-40% biomass (e.g. elephant grass at 20% moisture). A small amount of flux material (such as limestone) may be included, with the balance comprising iron ore fines.

The physical structure of the DRI at the end of the process is not critical. The physical structure may be friable and break easily or it could resemble a robust 3D “chocolate bar”.

Either way, with further reference to FIG. 1, the DRI is fed into an insulated vessel (not shown) which is configured to transport the DRI (hot) to a downstream electric melting furnace (not shown). Here a feed system (not shown) can accept the hot DRI from the vessel and pass the DRI through a system of (for example) pushers and breaker bars (not shown) in order to feed the DRI into the electric melting furnace, including any furnace bath, for the production of steel.

It is noted that those structural components that are not specifically shown in FIG. 1 are generally standard components within the iron industry and the skilled person would be able to make an appropriate selection of the components.

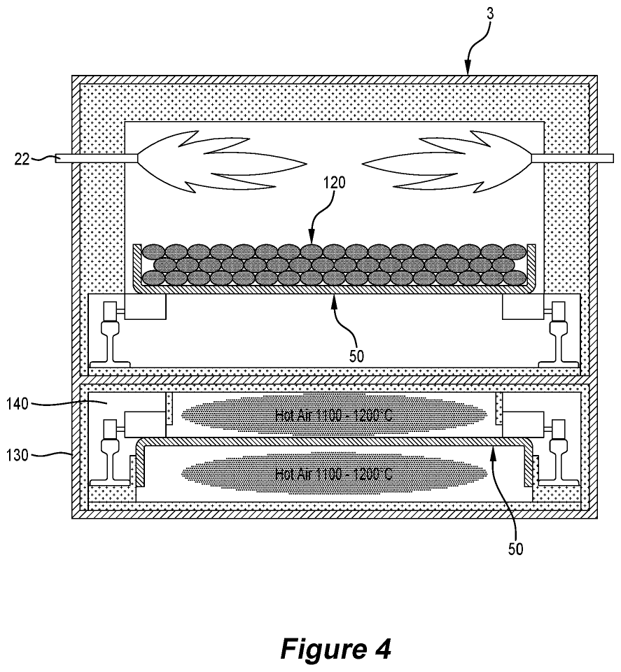

As an example of a selection that could be made, reference is made to the linear heath system shown in U.S. Pat. No. 7,413,592 in the name of Nu-iron Technology, LLC. FIG. 1 discloses a conveyor that has a segmented base in the form of a plurality of individual trays (as further detailed in FIG. 4 and FIG. 5A) that could form a segmented base of an endless conveyor and shows how the conveyor returns from an outlet of the furnace to the inlet of the furnace and holds residual heat. To be clear, DRI cooling zone 34 in FIG. 1 effectively teaches a forced cooling of the segment trays before their return to the feed zone 27 (that accordingly teaches away from the subject invention).

FIG. 2 is a process flowsheet diagram illustrating one embodiment of a method for producing direct reduced iron (DRI) according to the invention from cold-formed briquettes of iron ore and biomass in the furnace of FIG. 1.

The data in the diagram of FIG. 2 is derived from a model developed by the applicant and illustrates an embodiment of the method carried out in the linear hearth furnace arrangement of FIG. 1.

With further reference to FIG. 2, in the described embodiment, cold-formed briquettes are continuously fed through a feeding device (not shown) onto a refractory or metallic base of a conveyor travelling at around 5 m/min, with the briquettes forming a bed depth of around 60 mm. The feed system delivers around 80 tonnes per hour of briquettes into the furnace. The effective width of the base is four (4) metres.

The briquettes comprise 37% elephant grass at 20% water, 5% limestone and 58% Pilbara Blend iron ore fines.

The length of the preheat zone 20 is 140 metres and is divided into 4 sections for ease of processing controls.

The length of the final reduction zone 30 is 60 metres with 50 microwave energy input units 32 extending downwardly into the top space thereof.

As described above in relation to FIG. 1, briquettes are heated as they are transported through the preheat zone 20, with volatiles being released as a gas and combusted in the preheat zone 20 and iron ore in the briquettes being partially reduced in the preheat zone 20.

The residence time of briquettes in the preheat zone 20 is 26.4 mins.

With reference to FIG. 2, the briquettes leave the preheat zone 20 at 900° C. at a rate of 42.6 t/h and a metallisation of 67.5%.

With further reference to FIG. 2, the briquettes are heated further in the final reduction zone 30 via the microwave energy input units 32. The iron ore in the briquettes is reduced further and produces 138.7 t/h DRI, with a composition of 95.3 wt. %, Fe, 5.89 wt. % C, 0.179 wt. % P, and 0.022 wt. % S at a temperature of 1150° C. The residence time of briquettes in the final reduction zone 30 is 11.3 mins. The reduction of iron ore in the briquettes generates gas that includes combustible gases such as CO. The FIG. 2 model assumes that 2.0 kNm³/h tramp air entering the final reduction zone 30. The tramp air post-combusts a portion of the combustible gases in the gas generated in the final reduction zone 30, resulting in a post combustion degree of 22.5%.

The DRI is discharged continuously from the conveyor 50 at the discharge zone 40. As shown in FIG. 1, the discharge zone 40 may be configured with an enclosed discharge chute 42 that has a downwardly-directed outlet 46 that has a flow control valve 44 that can be selectively operated to allow DRI to flow through the outlet 46.

The hot DRI is transported for use as a feed material in an open arc furnace (not shown) that produces molten iron at a rate of 109 tph, with a C concentration of 3.0 wt. %, S concentration of 0.012 wt. %, and a P concentration of 0.032 wt. %

A gas flow restriction is created between the two zones 20, 30 by the baffle wall 60 shown in FIG. 1 that changes the top space heights between the two zones, with the top space height and the overall transverse cross-sectional area of the final reduction zone 30 being less than that of the preheat zone 20.

In the FIG. 2 embodiment, gas flows from the final reduction zone 30 to the preheat zone 20. In the FIG. 2 model this gas has a post combustion degree of around 22.5% in the final reduction zone. The amount of post combustion will vary as a function of the amount of tramp air (if more than negligible) that flows into the final reduction zone 30, such as from the discharge zone 40. Therefore, there is considerable combustible gas in this gas as it flows into the preheat zone 20.

In the FIG. 2 embodiment, the amount of gas flowing from the final reduction zone 30 to the preheat zone 20 is 9.3 kNm³/h at a gas velocity of 5 m/s.

Typically, the operating range is 200-300 Nm³/tonne of DRI discharged from the furnace, and the gas velocity at the interface between the final reduction zone 30 and the preheat zone 20 is around 4-10 m/s (nominally 5 m/s).

As described in relation to FIG. 1, the gas flows into and along the preheat zone 20, counter-current to the movement of briquettes through the furnace, and the gas is subjected to incremental combustion as it passes through the plurality of air or oxygen-enriched air fed burners 22 which, in this embodiment, receive preheated (and/or oxy-enriched) air.

Typically, the post-combustion profile in the preheat zone 20 is typically 35-45% at the hot end (i.e. the final reduction zone 30 end), increasing gradually to around 85-90% at the flue gas outlet 70 end. The preheat zone top space is therefore maintained in a bulk reducing condition all the way along its length in the embodiment, with feed oxygen being consumed rapidly in the vicinity of each burner 22 (in a small localised region).

Off-gas at the flue gas outlet 70 end is then ducted (hot, around 1100-1300° C.) to an afterburning chamber 80, where final combustion of combustible gas in the gas is performed.

The gas from the afterburning chamber 80 is then used (in this embodiment) to preheat air for the burners 22 in the preheat zone 20 via a heat exchanger 90, before passing to a boiler 100 for final heat recovery via heat exchange in the boiler and then discharge as a flue gas to the atmosphere. FIG. 2 indicates that the flue gas has a temperature of 202° C.

After the hot DRI is discharged from the conveyor 50 at the discharge zone 40, the conveyor 50 circles back in its endless path to the inlet end of the furnace so that the conveyor 50 can be re-loaded with new briquettes in the feed zone 10 and transport the briquettes through the chamber. The refractory or metallic base material of the conveyor 50 has residual heat from the chamber when the conveyor 50 returns to the feed zone 10 and this recycled heat contributes to heating the feed briquettes.

There is considerable data in FIG. 2 in addition to that described above. The data in FIG. 2 describes the operating conditions for one embodiment of the invention based on a model developed by the applicant. The model is one of a number of models that could be developed as a basis for determining operating conditions for embodiments of the invention in a range of different embodiments of apparatus in accordance with the invention. The invention does not include the model.

The data in FIG. 2 necessarily contains multiple assumptions regarding kinetic parameters—precise details may shift as a result of different kinetics. However, the principles are not expected to change. Although the current example is based on preheated air, additional oxygen could be added to the air mixture prior to heating so that the ratio of air to oxygen could be varied as an additional control parameter to further optimise the process.

It is evident from FIG. 2 that the method and apparatus of the invention are a viable option for effective and efficient production of direct reduced iron (DRI) from iron ore and biomass, with the “recycled” heat of the furnace 3 making a significant contribution to the overall heat requirements of the method/apparatus.

The embodiment of the invention shown in FIGS. 1 and 2 does not include any measures to minimise heat loss from the unloaded conveyor 50 as it travels in a return path from the outlet in the discharge zone 40 to the inlet in the feed zone 10.

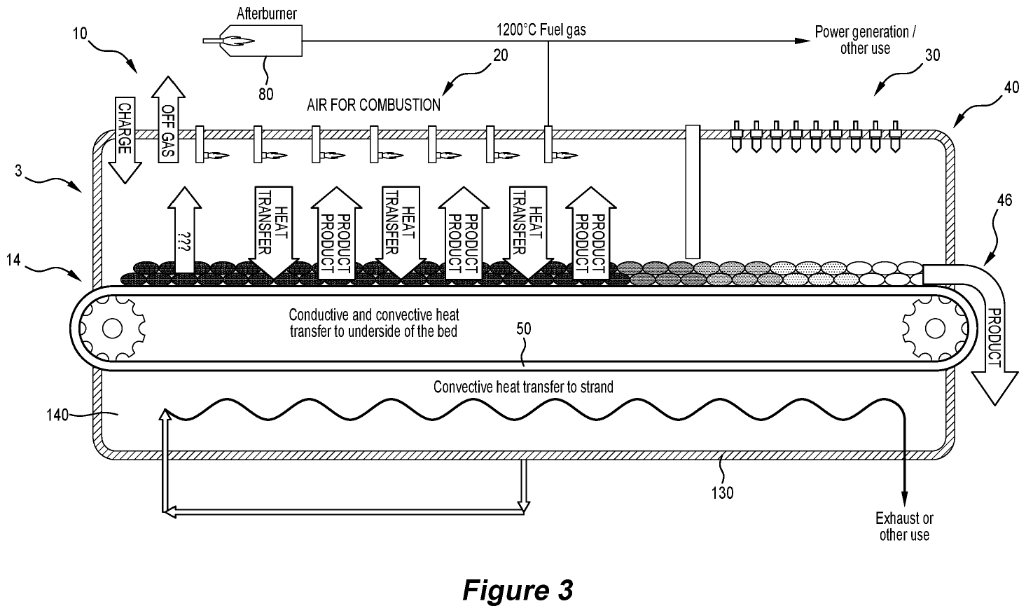

FIGS. 3 and 4 are schematic diagrams of an embodiment of the apparatus of the invention that includes specific measures to minimise heat loss and thereby maintain heat in the unloaded conveyor 50 when it returns to the feed zone 10 of the furnace.

FIG. 3 is a vertical cross-section and FIG. 4 is a transverse cross-section of the apparatus diagrammatically shown in these Figures.

The furnace shown in FIGS. 3 and 4 includes the same basic structure of the embodiment shown in FIG. 1, and the same reference numerals are used to describe the same features.

With reference to FIGS. 3 and 4, the furnace 3 also includes a thermally-insulated, typically refractory-lined, housing 130 that defines a lower chamber 140 through which the conveyor 50 passes in its return path from the outlet 46 in the discharge zone 40 to the inlet 14 in the feed zone 10. The housing 130 may be of any suitable construction and be made from any suitable materials.

In addition, the furnace 3 is configured so that at least a part of the hot gases generated in the chamber of the furnace 3 as briquettes 120 move successively through the preheat zone 20 and the final reduction zone 30 flow into the lower chamber 140 and heat the chamber to a temperature in a range of 1100-1200° C. and thereby at least minimise heat loss from the unloaded conveyor on its return path and thereby maintain heat in the unloaded conveyor 50 when it returns to the feed zone 10 of the furnace.

In modelling work, the applicant has determined that it is possible to minimise heat loss to an extent that the base of the conveyor 50 has a hot face temperature of at least 500° C. when it returns to the feed zone 10 and before it is loaded with briquettes and thereby returns heat to the furnace and contributes to heating briquettes.

The furnace 3 is also configured to use furnace gases beneficially to generate heat. Specifically, the furnace 3 is configured so that at least a part of the gases that are discharged via the flue gas outlet 70 in the preheat zone 20 are subsequently post-combusted in the afterburning chamber 80 (see FIG. 2, as well as FIGS. 3 and 4). The heat gas can be used in the furnace 3 or in other applications.

Many modifications may be made to the embodiment described above without departing from the spirit and scope of the invention.

By way of example, whilst the embodiment shown in FIG. 2 includes a 80 tonnes per hour briquette fed furnace has an effective width of 4 m wide by 200 m long (with a bed depth of 60 mm), with the briquettes comprising 38% elephant grass at 20% water, 5% limestone and 57% Pilbara Blend iron ore fines, it can readily be appreciated the invention is not confined to this size briquette bed with this composition of the briquettes.

By way of further example, whilst the conveyor 50 in the above embodiments has a refractory or metallic material base, the invention is not limited to this arrangement and extends to any suitable conveyor including a base formed from any suitable material.

By way of further example, whilst the above embodiments include the use of nitrogen gas injection to generate and maintain the anoxic environment in the final reduction zone, the invention is not limited to this particular gas. In addition, the invention is not confined to such gas injection at all if the gas generated via reduction of iron ore in the final reduction zone 30 is sufficient to maintain the required anoxic environment.

By way of further example, whilst the above embodiments include continuous operation, the invention is not so limited.

### REFERENCES

1. Vogl, V et al, Assessment of hydrogen direct reduction for fossil-free steelmaking, Journal of Cleaner production 203 (218) 736-745
2. Strezov, V, Iron ore reduction using sawdust: experimental analysis and kinetic modelling, renewable Energy 31(12) 1892-1905, October 2006

1. A method for producing direct reduced iron (DRI) from briquettes of a composite of iron ore fragments and biomass in a linear hearth furnace including a refractory-lined chamber having the following zones along the length of the furnace between an inlet for briquettes of iron ore fragments and biomass and an outlet for direct reduced iron: a feed zone that includes the inlet, a preheat zone, a final reduction zone and a discharge zone that includes the outlet, and an endless conveyor that moves through the zones from the inlet to the outlet and then returns to the inlet, with the conveyor having a base for receiving and supporting briquettes, the method including:
a) feeding briquettes onto the base of the conveyor in the feed zone;
b) transporting briquettes on the conveyor through the preheat zone and heating briquettes and reducing iron ore in briquettes and releasing volatiles in biomass in briquettes, with heating including generating heat by burning combustible gases in a top space of the preheat zone via a plurality of air or oxygen-enriched air fed burners, with the combustible gases including combustible gases generated within the furnace;
c) transporting heated briquettes on the conveyor from the preheat zone through the final reduction zone, with the final reduction zone being an anoxic environment, and supplying electromagnetic energy, such as microwave energy, into the final reduction zone and heating briquettes and reducing iron ore in briquettes and forming DRI;
d) transporting DRI on the conveyor to the discharge zone at the outlet and discharging DRI from the discharge zone; and
e) returning the unloaded conveyor from the outlet to the inlet of the furnace and repeating step (a) of feeding briquettes onto the base of the conveyor, with the base of the conveyor having a hot face temperature of at least 500° C. when it returns to the feed zone and before it is loaded with briquettes and thereby returning heat to the furnace and contributing to heating briquettes.

2. The method defined claim 1 wherein step (a) includes forming a relatively uniform bed of briquettes on the conveyor.

3. The method defined in claim 1 wherein the hot face temperature of the base of the conveyor in the feed zone before it is loaded with briquettes in the feed zone is at least 800° C. so as to recover heat therefrom.

4. The method defined in claim 3 wherein the hot face temperature of the unloaded base of the conveyor in the feed zone before it is loaded with briquettes in the feed zone is at least 900° C. so as to recover heat therefrom.

5. The method defined in claim 1 includes returning the conveyor to the inlet through a thermally-insulated chamber in a lower region of the furnace to maintain heat or minimise heat loss in the base of the conveyor between the outlet and the inlet of the furnace.

6. The method defined in claim 4 includes heating the lower region of the furnace and therefore the base of the conveyor using hot gases from the furnace.

7. The method according to claim 6 includes heating the base of the conveyor by transferring at least a part of hot gases produced by combusting combustible gases in the preheat zone to the lower region of the furnace and/or by transferring at least a part of hot gases produced in the final reduction zone to the lower region of the furnace and/or by electrical heating.

8. (canceled)

9. (canceled)

10. The method defined in claim 1 wherein the mass percentage of biomass in briquettes is 20-45%, typically 30-45%, by weight on a wet (as-charged) basis.

11. The method defined in claim 10 wherein the biomass includes a significant lignocellulosic component.

12. The method defined in claim 9 wherein the balance of the composition of briquettes is (a) iron ore fragments (b) optionally flux/binder materials and (c) optionally additional carbonaceous material, such as coal or pre-charred biomass, in an amount of <5% by weight of the total weight of individual briquettes.

13. The method defined in claim 1 includes controlling the method so that the bulk temperature of briquettes is at least 500° C. when briquettes leave the preheat zone and pass to the final reduction zone.

14. The method defined in claim 1 wherein step (c) includes electromagnetic energy heating briquettes by at least 250° C. in the final reduction zone.

15. The method defined in claim 1 includes releasing at least 90% of volatiles in biomass in the briquettes as a gas in the preheat zone.

16. The method defined in claim 1 wherein step (c) includes generating a higher pressure of gases in the final reduction zone compared to gas pressure in the preheat zone and thereby causing gases generated in the final reduction zone to flow counter-current to the direction of movement of briquettes on the conveyor through the furnace.

17. The method defined in claim 1 includes generating heat in step (b) by burning combustible gases in a plurality of burners that are spaced apart along the length of the top space of the preheat zone of the furnace and/or spaced across the width of the preheat zone of the furnace.

18. The method defined in claim 17 includes generating heat in step (b) by burning combustible gases in a plurality of burners that are spaced across the width of the preheat zone of the furnace.

19. The method defined in claim 17 includes adjusting the amount of air or oxygen-enriched air fed to each burner in step (b) to compensate for variations in combustible gas in the top space of the preheat zone.

20. (canceled)

21. An apparatus for producing direct reduced iron (DRI) from briquettes of a composite of iron ore fragments and biomass, the apparatus including a linear hearth furnace that includes a refractory-lined chamber having:
(a) an inlet for briquettes of iron ore and biomass at one end and an outlet for direct reduced iron at the other end,
(b) the following zones:
(i) a feed zone that includes the inlet for briquettes;
(ii) a preheat zone for heating briquettes and reducing iron ore in briquettes and releasing volatiles in biomass in briquettes, the preheat zone including a plurality of air or oxygen-enriched air fed burners for generating heat by burning combustible gases in a top space of the preheat zone, with the combustible gases including combustible gases originating within the furnace,
(iii) a final reduction zone for heating briquettes and reducing iron ore in briquettes and forming DRI, the final reduction zone including a means for supplying electromagnetic energy, such as microwave energy, into the final reduction zone for heating briquettes; and
(iv) a discharge zone that includes the outlet, the discharge zone being configured for discharging DRI from the furnace; and
(c) an endless conveyor having a base for receiving and transporting briquettes through the zones from the inlet to the outlet and then returning to the inlet,
the apparatus being configured to return the conveyor from the outlet to the inlet of the furnace with the base having a hot face temperature of at least 500° C. when it returns to the feed zone and before it is loaded with briquettes thereby recovering heat from the furnace and then returning heat to the furnace and contributing to heating briquettes.

22. The apparatus defined in claim 21 wherein the conveyor includes a return leg that extends through a thermally-insulated chamber in a lower region of the furnace configured to maintain heat or minimise heat loss in the base of the conveyor between the outlet and the inlet of the furnace.

23. (canceled)

24. (canceled)

25. The apparatus defined in claim 21 configured to generate a higher pressure of gas in the final reduction zone compared to gas pressure in the preheat zone to cause gases generated in the final reduction zone to flow counter-current to the direction of movement of briquettes on the conveyor through the furnace.

26. (canceled)
